(19) United States
(12) Patent Application Publication
(10) Pub. No.: US 2025/0086441 A1
(43) Pub. Date: Mar. 13, 2025

(54) ANSWERING SOFTWARE-RELATED QUESTIONS WITH GENERATIVE AI

(71) Applicant: The Toronto-Dominion Bank, Toronto (CA)

(72) Inventors: Francis James Alexander Guttridge, Vaughan (CA); Dino Paul D'Agostino, Richmond Hill (CA); A Warren Pratten, London (CA); Shahzad Mohammed, Toronto (CA); Arvind Chikkalavalasa, Milton (CA); Waqas Nawaz, Waterdown (CA)

(73) Assignee: The Toronto-Dominion Bank, Toronto (CA)

(21) Appl. No.: 18/466,771

(22) Filed: Sep. 13, 2023

(51) Int. Cl. G06N 3/0475; G06N 3/0455; G06N 3/08

(52) U.S. Cl. CPC G06N 3/0475; G06N 3/0455; G06N 3/08

(57) ABSTRACT

An example operation may include one or more of storing web pages with content about a software program, receiving a natural language input with a question about the software program from an input field of a user interface, generating an answer to the question about the software program based on execution of a generative artificial intelligence (GenAI) model on the question from the input field and the plurality of web pages stored in the memory, and displaying the answer to the question via the user interface.

### BACKGROUND

Software programs, software applications, software architecture, source code, and the like, contain valuable information therein. However, for many organizations, the content within their software is largely a black box other than the group of users that developed the software. Trying to reconstruct the contents of a software program can be difficult. Furthermore, audits are often performed on software systems to ensure that the software complies with various policies and procedures including both internal and external from the organization.

Meanwhile, generative artificial intelligence (GenAI) is an artificial intelligence that is capable generating text, images, and other media from generative artificial intelligence models such as large language models, multi-modal large language models, neural networks, and the like. A GenAI model can learn patterns and structure of the training data input to the GenAI model during training, and then use what is learned during the training to generate new data with similar characteristics.

### SUMMARY

One example embodiment provides an apparatus that may include a memory configured to store a plurality of digital training manuals that comprise policies which are to be followed by users, and a processor coupled to the memory configured to detect an occurrence of a triggering condition, in response to the detection of the occurrence of the triggering condition, retrieve the plurality of digital training manuals from the memory and generate a user manual based on execution of a generative artificial intelligence (GenAI) model on the plurality of digital training manuals, and store the user manual in the memory.

Another example embodiment provides a method that includes one or more of storing a plurality of digital training manuals that comprise policies which are to be followed by users, detecting an occurrence of a triggering condition, in response to the detection of the occurrence of the triggering condition, retrieving the plurality of digital training manuals from the memory and generating a user manual based on an execution of a generative artificial intelligence (GenAI) model on the plurality of digital training manuals, and storing the user manual in the memory.

A further example embodiment provides a computer-readable medium comprising instructions, that when read by a processor, cause the processor to perform one or more of storing a plurality of digital training manuals that comprise policies which are to be followed by users, detecting an occurrence of a triggering condition, in response to the detection of the occurrence of the triggering condition, retrieving the plurality of digital training manuals from the memory and generating a user manual based on an execution of a generative artificial intelligence (GenAI) model on the plurality of digital training manuals, and storing the user manual in the memory.

A further embodiment provides an apparatus that may include a display, a memory configured to store web pages with content about a software program, and a processor coupled to the display and the memory configured to receive a natural language input with a question about the software program from an input field of a user interface, generate an answer to the question about the software program based on execution of a generative artificial intelligence (GenAI) model on the question from the input field and the plurality of web pages stored in the memory; and display on the display the answer to the question via the user interface.

A further example embodiment provides a method that includes one or more of storing web pages with content about a software program, receiving a natural language input with a question about the software program from an input field of a user interface, generating an answer to the question about the software program based on execution of a generative artificial intelligence (GenAI) model on the question from the input field and the plurality of web pages stored in the memory, and displaying the answer to the question via the user interface.

A further example embodiment provides a computer-readable medium comprising instructions, that when read by a processor, cause the processor to perform one or more of storing web pages with content about a software program, receiving a natural language input with a question about the software program from an input field of a user interface, generating an answer to the question about the software program based on execution of a generative artificial intelligence (GenAI) model on the question from the input field and the plurality of web pages stored in the memory, and displaying the answer to the question via the user interface.

A further embodiment provides an apparatus that may include a memory configured to store software architecture documents which include text-based descriptions of architecture components, and a processor coupled to the memory configured to train a generative artificial intelligence (GenAI) model to understand the architecture components based on the software architecture documents in the memory, receive an input comprising a description of a software architecture implemented by a computing platform, execute the GenAI model based on the description of the software architecture to generate a description of a change to be made to the software architecture, and output the description of the change on a user interface.

A further example embodiment provides a method that includes one or more of storing software architecture documents which include text-based descriptions of architecture components, training a generative artificial intelligence (GenAI) model to understand the architecture components based on the software architecture documents in the memory, receiving an input comprising a description of a software architecture implemented by a computing platform, executing the GenAI model based on the description of the software architecture to generate a description of a change to be made to the software architecture, and outputting the description of the change on a user interface.

A further example embodiment provides a computer-readable medium comprising instructions, that when read by a processor, cause the processor to perform one or more of storing software architecture documents which include text-based descriptions of architecture components, training a generative artificial intelligence (GenAI) model to understand the architecture components based on the software architecture documents in the memory, receiving an input comprising a description of a software architecture implemented by a computing platform, executing the GenAI model based on the description of the software architecture to generate a description of a change to be made to the software architecture, and outputting the description of the change on a user interface.

A further embodiment provides an apparatus that may include a memory configured to store a repository of test data, and a processor coupled to the memory configured to receive a request for new test data to be generated for a software program, where the request comprises a text-based description of the new test data, identify one or more code modules included on the software program based on source code of the software program stored in the memory, execute a generative artificial intelligence (GenAI) model on the text-based description of the new test data and the one or more code modules to generate test data for testing the one or more code modules and store the test data in the repository of test data.

A further example embodiment provides a method that includes one or more of storing a repository of test data, receiving a request for new test data to be generated for a software program, where the request comprises a text-based description of the new test data, identifying one or more code modules included on the software program based on source code of the software program stored in the memory, executing a generative artificial intelligence (GenAI) model on the text-based description of the new test data and the one or more code modules to generate test data for testing the one or more code modules, and storing the test data in the repository of test data.

A further example embodiment provides a computer-readable medium comprising instructions, that when read by a processor, cause the processor to perform one or more of storing a repository of test data, receiving a request for new test data to be generated for a software program, where the request comprises a text-based description of the new test data, identifying one or more code modules included on the software program based on source code of the software program stored in the memory, executing a generative artificial intelligence (GenAI) model on the text-based description of the new test data and the one or more code modules to generate test data for testing the one or more code modules, and storing the test data in the repository of test data.

### BRIEF DESCRIPTION OF THE DRAWINGS

FIG. 1 is a diagram illustrating a generative artificial intelligence (GenAI) computing environment for responding to requests associated with software according to example embodiments.

FIG. 2 is a diagram illustrating a process of executing a machine-learning model on input content according to example embodiments.

FIGS. 3A-3C are diagrams illustrating processes for training a machine learning model according to example embodiments.

FIG. 4 is a diagram illustrating a process of a GenAI model prompting a user for information about a software test according to example embodiments.

FIGS. 5A-5C are diagrams illustrating a process of continuously updating a user manual of compliance according to example embodiments.

FIG. 6A-6C are diagrams illustrating a process of answering questions about a software program according to example embodiments.

FIGS. 7A-7B are diagrams illustrating a process of recommending a new software component based on a description of a software architecture according to example embodiments.

FIGS. 8A-8B are diagrams illustrating a process of generating software tests and test data according to example embodiments.

FIG. 9A is a diagram illustrating a method of generating an evolving user manual of compliance according to example embodiments.

FIG. 9B is a diagram illustrating a method of answering questions about a software program according to example embodiments.

FIG. 9C is a diagram illustrating a method of generating a description of a change to be made to a software architecture according to example embodiments.

FIG. 9D is a diagram illustrating a method of generating test data based on a natural language input according to example embodiments.

FIG. 10 is a diagram illustrating a computing system that may be used in any of the example embodiments described herein.

### DETAILED DESCRIPTION

It is to be understood that although this disclosure includes a detailed description of cloud computing, implementation of the teachings recited herein is not limited to a cloud computing environment. Rather, embodiments of the instant solution are capable of being implemented in conjunction with any other type of computing environment now known or later developed.

The example embodiments are directed to a platform that uses generative artificial intelligence (GenAI) to provide knowledge about software programs held in a repository. The platform may receive an input from a user, such as a text input, a document, or speech that is then converted into text and the like, and respond with an answer to the input. Here, a generative artificial intelligence (GenAI) model may receive the input from the user and generate an answer based on its training. The answer may include a text-based description, an image, a combination thereof, and the like. In some embodiments, the GenAI model may trained to understand software programs, software architecture, source code, software tests, test data, and the like based on a large corpus of documentation.

For example, the model may ingest web pages, source code files, documentation, and other data about the software program. The system may also use web page scrapers or crawlers to gather content from website pages and fetch codebases from repositories or storage. It can further ingest documentation from user manuals, frequently asked question (FAQ) resources, application programming interface (API) guides, and help files. The system can pull data from forum discussions. Q&A platforms, user reviews, or other data sources that provide insight into the software program. Once the system has gathered the data, it processes the data to clean and remove irrelevant information, parses source code to extract methods, comments, and variables, and ingests data from different file formats (HTML, PDF, Excel, etc.). The cleaned data becomes training data for the GenAI model.

The system is now ready for questions submitted through a user interface or sourced from files or an API. When the GenAI model receives a question, it generates a response based on its learned patterns. Feedback can be gathered and submitted to the GenAI model to refine answers that are not satisfactory and help the model continuously learn and maintain relevant results. Throughout this process, the GenAI model integrates its foundational knowledge (from its pre-training phase) with the specific details of the software in question, allowing it to generate detailed and relevant answers about the software's features.

Furthermore, the GenAI model may also be trained to understand software testing and software test data.

The GenAI model may ingest and learn from test data held in a software repository. For example, the GenAI model may ingest tests that have been performed on a software application along with the test data used during the tests and the results. The GenAI model may then receive a natural language input and, in response, output a new batch of test data in response to the natural language input. Here, the natural language input may include a document (e.g., a description of the test data required, a software test, etc.), an input on a user interface, speech received and converted to text by a Text-to-speech converter, or the like. The test data may then be executed with a software test in a testing environment.

According to various embodiments, the GenAI model may be a large language model (LLM), such as a multimodal large language model. As another example, the GenAI model may be a transformer neural network (“transformer”) or the like. The GenAI model is capable of understanding connections between text (e.g., source code, user interface descriptions, document descriptions, etc.) and components (e.g., boxes, lines, arrows, software architecture, etc.) within software-related drawings such as flowcharts, architecture diagrams, and the like. For example, the GenAI model may include libraries and deep learning frameworks that enable the GenAI model to create realistic diagrams based on text inputs.

The instant solution uses generative AI to identify valuable information within a repository of software and provide answers to queries, recommendations based on document inputs, recommendations based on text inputs, recommendations based on image inputs, and the like. The model can be used to provide a better picture of the “black box” of software that normally exists within an organization.

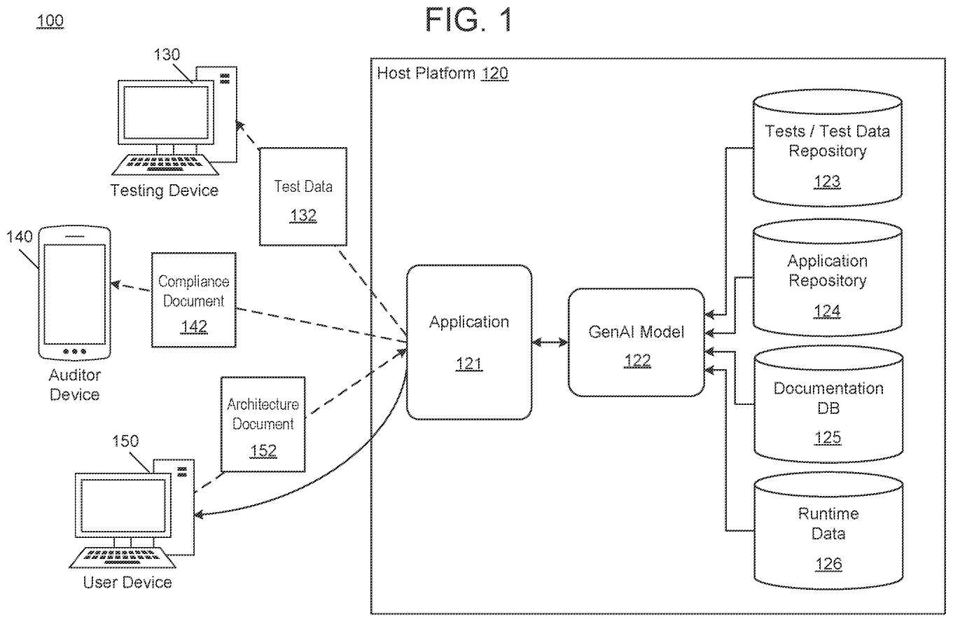

FIG. 1 illustrates a GenAI computing environment 100 for generating responses about software stored by a host platform 120 according to example embodiments. In this example, the host platform 120 may be a cloud platform, web server, etc., that hosts software applications and other software programs that are hosted and publicly available on the Internet. The software may be accessed via a URL, mobile application, etc.

For example, a software application 121 may be hosted by the host platform 120 and may allow users to chat with software that is stored at the host platform 120. The software application 121 may also provide a detailed understanding of a software program stored at the host platform 120. The software application 121 may also generate tests and test data from software testing results held by the host platform 120.

In the example, embodiments, the host platform 120 may include one or more generative artificial intelligence (GenAI) models, including GenAI model 122, which is capable of prompting a user for information (e.g., images, text, etc.) and generating answers and responses to the prompts. The GenAI model 122 can also interpret documents and other drawings. Although not shown, the host platform 120 may also include one or more additional models, including one or more machine learning models, one or more artificial intelligence (AI) models, one or more additional GenAI models, and the like. The models, including the GenAI model 122, may be held by the host platform 120 within a model repository (not shown).

In the example embodiments, the GenAI model 122 may be trained based on software tests and test data stored in a test data store 123, software applications/source code that is stored in a repository 124, architecture documents, best practice documents, reviews, FAQs, etc., stored in a database 125, and runtime data from a software program, application, etc., which is held in a data store 126. For example, the software architecture documents may be stored within the data store 126 on the host platform 120. Here, the runtime data may include runtime data/flow between the software components of the software architecture and may be used by the system to understand and provide a description of a “real-time” composition of the software.

As an example, the runtime data may include API calls, database queries, data transfers, method calls, and the like, which can be used by the GenAI model 122 to understand the code modules within the software program/application. In this example, the GenAI model 122 may identify the current components that are running within the software program based on the runtime data. This method is more accurate than a user “remembering” the content within the software architecture because it is based on actual runtime data that is generated by the software systems in the software architecture.

The GenAI model 122 can understand connections between entries in the runtime data/log data and diagram components.

In the example of FIG. 1, the software application 121 may receive a request for test data from a user device 132. Here, the request may include a document such as a software test. As another example, the request may include a description of the test to be performed, the test data needed, or the like.

The software application 121 may provide the document/description to the GenAI model 122, which generates/outputs a test data 130. The test data 130 may be stored in a file and delivered to the user device 132 by the software application 121.

As another example, the software application 121 may receive a question about a software program from a user device 140.

As an example, the question may refer to an audit of the software program for internal or external purposes.

The software application 121 may input the question into the GenAI model 122 (e.g., via an executable script, etc.). In response, the GenAI model 122 may generate a description of the components that are included within the software program, integrate the description into a document 142, and send the document 142 to the user device 140.

As another example, the software application 121 may receive a document from a user device 150, such as an architecture document 152. As an example, the architecture document may include an architecture diagram of a software component such as a program, etc. The software application 121 may input the architecture document 152 into the GenAI model 122. In response, the GenAI model 122 may generate a description of a recommended change to be made to the software program based on the architecture document 152 provided. In some embodiments, the GenAI model 122 may generate the source code for such a software program and output the source code along with the description to the user device 150.

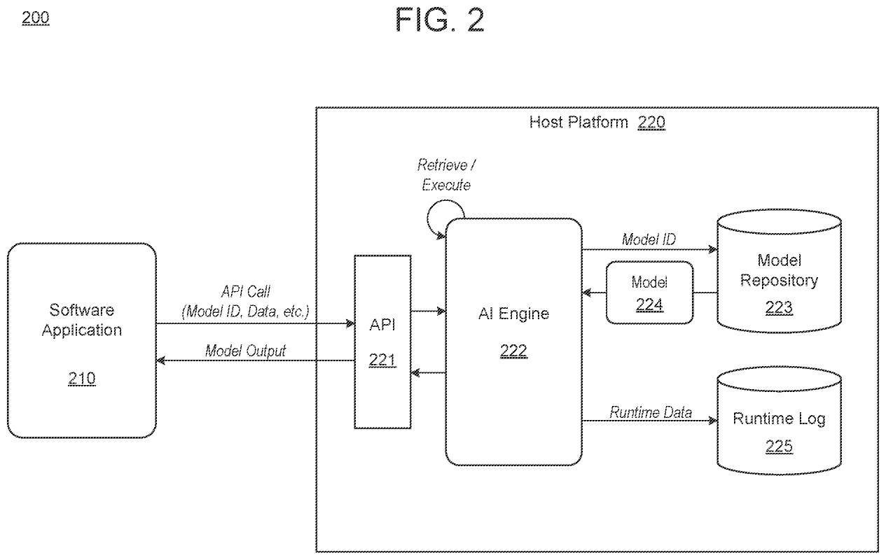

FIG. 2 illustrates a process 200 of executing a model 224 on input content according to example embodiments. As an example, the model 224 may be the GenAI model 122 described with respect to FIG. 1. However, embodiments are not limited thereto. Referring to FIG. 2, a software application 210 may request execution of the model 224 by submitting a request to the host platform 220. In response, an AI engine 222 may receive the request and trigger the model 224 to execute within a runtime environment of the host platform 220.

In FIG. 2, the AI engine 222 may control access to models that are stored within the model repository 223. For example, the models may include GenAI models. AI models, machine learning models, neural networks, and/or the like. The software application 210 may trigger execution of the model 224 from the model repository 223 via submission of a call to an API 221 (application programming interface) of the AI engine 222. The request may include an identifier of the model 224, such as a unique ID assigned by the host platform 220, a payload of data (e.g., to be input to the model during execution), and the like.

The AI engine 222 may retrieve the model 224 from the model repository 223 in response and deploy the model 224 within a live runtime environment. After the model is deployed, the AI engine 222 may execute the running instance of the model 224 on the payload of data and return a result of the execution to the software application 210.

In some embodiments, the payload of data may be a format that is not capable of being input to the model 224 nor read by a computer processor. For example, the payload of data may be in text format, image format, audio format, and the like. In response, the AI engine 222 may convert the payload of data into a format that is readable by the model 224, such as a vector or other encoding. The vector may then be input to the model 224.

In some embodiments, the software application 210 may display a user interface that enables a user to provide feedback from the output provided by the model 224. For example, a user may input a confirmation that the description of the software program generated by a GenAI model is correct or is liked.

This information may be added to the results of execution and stored within a log 225. The log 225 may include an identifier of the input, an identifier of the output, an identifier of the model used, and feedback from the recipient. This information may be used to subsequently retrain the model.

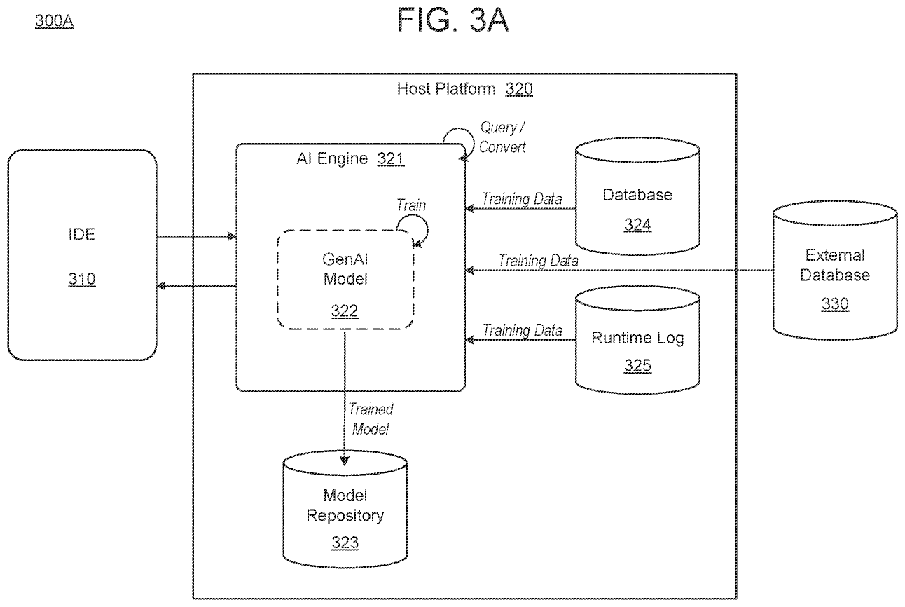

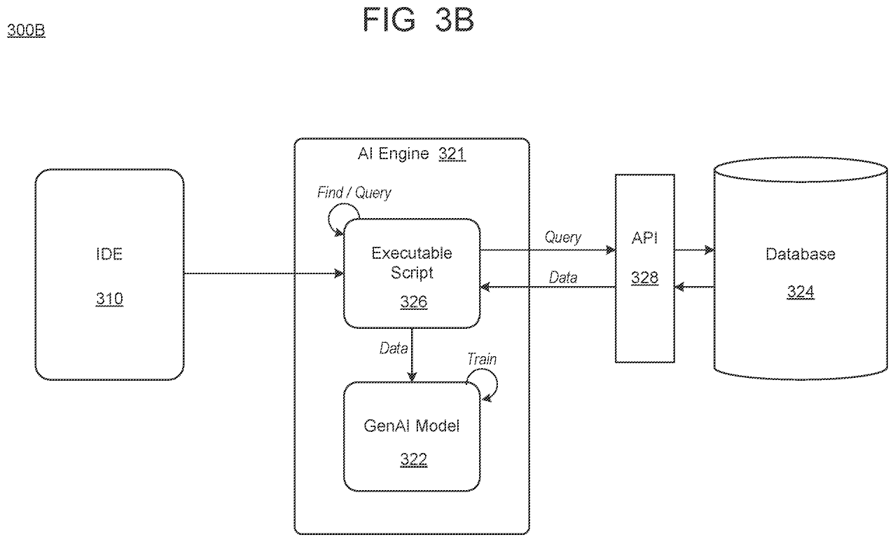

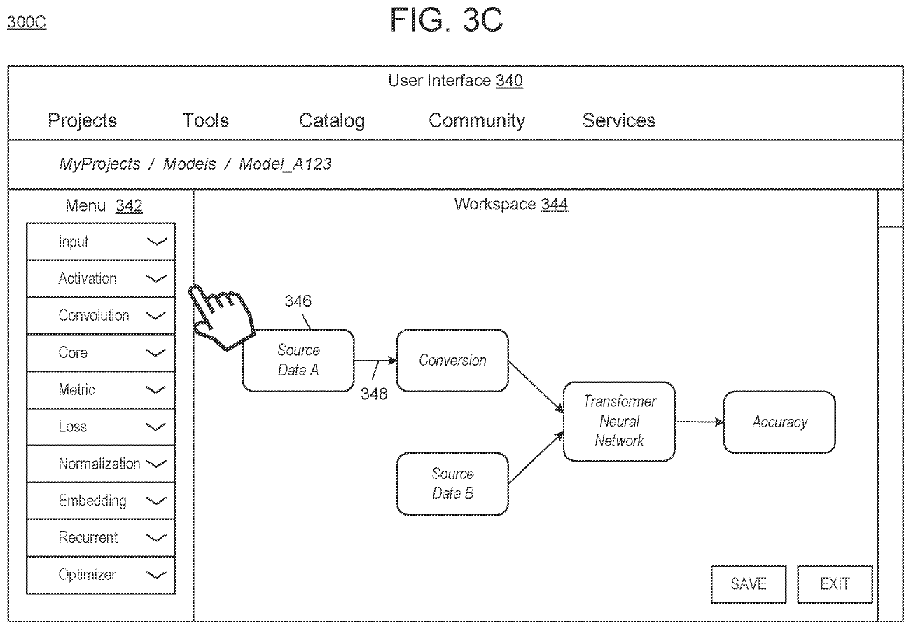

FIG. 3A illustrates a process 300A of training a GenAI model 322 according to example embodiments. However, it should be appreciated that the process 300A shown in FIG. 3A is also applicable to other types of models, such as machine learning models, AI models, and the like. Referring to FIG. 3A, a host platform 320, may host an IDE 310 (integrated development environment) where GenAI models, machine learning models, AI models, and the like may be developed, trained, retrained, and the like. In this example, the IDE 310 may include a software application with a user interface accessible by a user device over a network or through a local connection.

For example, the IDE 310 may be embodied as a web application that can be accessed at a network address, URL, etc., by a device. As another example, the IDE 310 may be locally or remotely installed on a computing device used by a user.

The IDE 310 may be used to design a model (via a user interface of the IDE), such as a generative artificial intelligence model that can receive text as input and generate custom imagery, etc. The model can then be executed/trained based on the training data established via the user interface. For example, the user interface may be used to build a new model. The training data for training such a new model may be provided from a training data store such as a database 324, which includes training samples from the web, from customers, and the like. As another example, the training data may be pulled from one or more external data stores 330 such as publicly available sites, etc.

During training, the GenAI model 322 may be executed on training data via an AI engine 321 of the host platform 320. The training data may include a large corpus of generic images and text that is related to those images. In the example embodiments, the training data may include software architecture diagrams (images) paired with descriptions (text) of the software architecture diagrams, software tests, test data, source code, runtime data, documentation, and the like. The model 322 may learn mappings/connections between text and imagery during the execution and can thus create diagrams of the software programs from input text, and vice-versa, can generate a test response to an input diagram. When the model is fully trained, it may be stored within the model repository 323 via the IDE 310 or the like.

As another example, the IDE 310 may be used to retrain the GenAI model 322 after the model has already been deployed.

Here, the training process may use executional results that have already been generated/output by the GenAI model 322 in a live environment (including any customer feedback, etc.) to retrain the GenAI model 322. For example, predicted outputs/images that are custom generated by the GenAI model 322 and the user feedback of the images may be used to retrain the model to further enhance the images that are generated for all users. The responses may include indications of whether the generated software architecture diagram is correct and, if not, what aspects of the diagram are incorrect. This data may be captured and stored within a runtime log 325 or other data store within the live environment and can be subsequently used to retrain the GenAI model 322.

FIG. 3B illustrates a process 300B of executing a training process for training/retraining the GenAI model 322 via an AI engine 321. In this example, a script 326 (executable) is developed and configured to read data from a database 324 and input the data to the GenAI model 322 while the GenAI model is running/executing via the AI engine 321. For example, the script 326 may use identifiers of data locations (e.g., table IDs, row IDs, column IDs, topic IDs, object IDs, etc.) to identify locations of the training data within the database 324 and query an API 328 of the database 324. In response, the database 324 may receive the query, load the requested data, and return it to the AI engine 321, where it is input to the GenAI model 322. The process may be managed via a user interface of the IDE 310, which enables a human-in-the-loop during the training process (supervised learning). However, it should also be appreciated that the system is capable of unsupervised learning as well.

The script 326 may iteratively retrieve additional training data sets from the database 324 and iteratively input the additional training data sets into the GenAI model 322 during the execution of the model to continue to train the model. The script may continue the process until instructions within the script tell the script to terminate, which may be based on a number of iterations (training loops), total time elapsed during the training process, etc.

FIG. 3C illustrates a process 300C of designing a new AI model via a user interface 340 according to example embodiments. As an example, the user interface 340 may be output as part of the software application which interacts with the IDE 310 shown in FIG. 3A, however, embodiments are not limited thereto.

Referring to FIG. 3C, a user can use an input mechanism to make selections from a menu 342 shown on the left-hand side of the user interface 340 to add pieces to the model such as data components, model components, analysis components, etc., within a workspace 344 of the user interface 340.

In the example of FIG. 3C, the menu 342 includes a plurality of graphical user interface (GUI) menu options, which can be selected to drill down into additional components that can be added to the model design shown in the workspace 344. Here, the GUI menu options include options for adding features such as neural networks, machine learning models, AI models, data sources, conversion processes (e.g., vectorization, encoding, etc.), analytics, etc.

The user can continue to add features to the model and connect them using edges or other means to create a flow within the workspace 344. For example, the user may add a node 346 to a diagram of a new model within the workspace 344. For example, the user may connect the node 346 to another node in the diagram via an edge 348, creating a dependency within the diagram. When the user is done, the user can save the model for subsequent training/testing.

According to various embodiments, the GenAI model described herein may be trained based on custom-defined prompts that are designed to draw out specific attributes associated with a software program, a software test, a software architecture, or the like. These same prompts may be output during live execution of the GenAI model. For example, a user may input a description of a software test to be performed, and the GenAI model may generate test data for the software test based on the prompt and the description input by the user. The prompts may be generated via prompt engineering that can be performed through the model training process, such as the model training process described above in the examples of FIGS. 3A-3C.

Prompt engineering is the process of structing sentences (prompts) so that they are understood by the GenAI model. Part of the prompting process may include delays/waiting times that are intentionally included within the script such that the model has time to think/understand the input data.

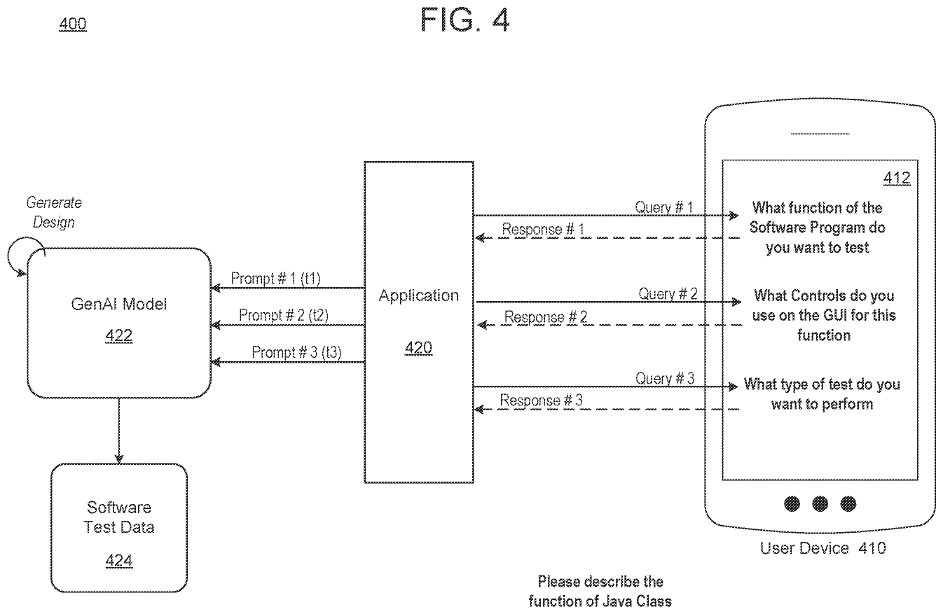

FIG. 4 illustrates a process 400 of a GenAI model 422 generating software test data 424 for testing a software program (not shown) based on prompts and responses to the prompts according to example embodiments.

Referring to FIG. 4, the GenAI model 422 may be hosted by a host platform and may be part of a software application 420 that is also hosted on the host platform. Here, the software application 420 may establish a connection with a user device 410, such as a secure network connection. The secure connection may include a PIN, biometric scan, password, username, TTL handshake, etc.

In the example of FIG. 4, the software application 420 may control the interaction of the GenAI model 422 on the host platform and the user device 410. In this example, the software application 420 may output queries on a user interface 412 of the user device 410 with requests for information from the user. The user may enter values into the fields on the user interface corresponding to the queries and submit/transfer the data to the software application 420, for example, by pressing a submit button, etc.

In this example, the application may combine the query with the response from the user interface and generate a prompt that is submitted to the GenAI model 422. For example, each prompt may include a combination of a query on the UI plus the response from the user. For example, if the query is “What function of the Software Program do you want to test?” and the response is “the 16-digit entry field on page three”, then the text from both the prompt and the response to the prompt may be submitted to the GenAI model 422.

In some embodiments, the software application 420 may deliberately add waiting times between submitting prompts to the GenAI model 422 to ensure that the model has enough time to “think” about the answer.

The waiting times may be integrated into the code of the software application 420, or they may be modified/configured via a user interface. Furthermore, the ordering of the prompts and the follow-up questions that are asked may be different depending on the answers given during the previous prompt or prompts. The content within the prompts and the ordering of the prompts can cause the GenAI model 422 to have architecture diagrams, descriptions of architecture diagrams, combinations of architecture diagrams, new architecture diagrams, and the like. Each prompt may include multiple components, including one or more of context, an instruction, input data, and an expected response/output.

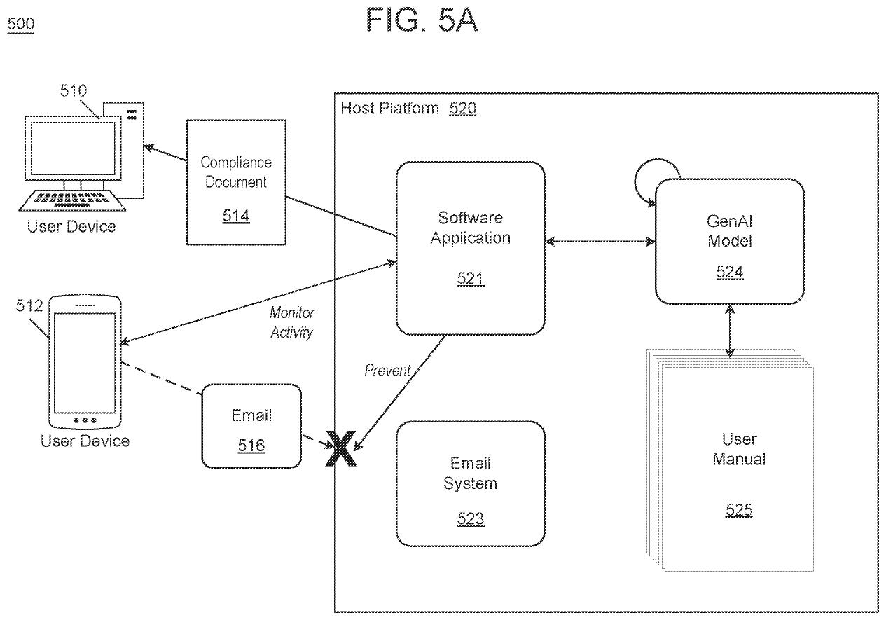

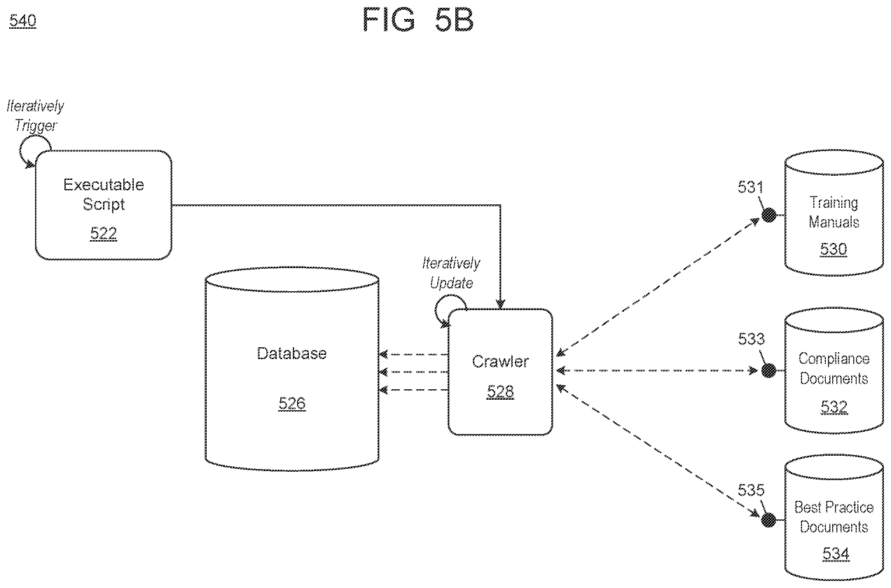

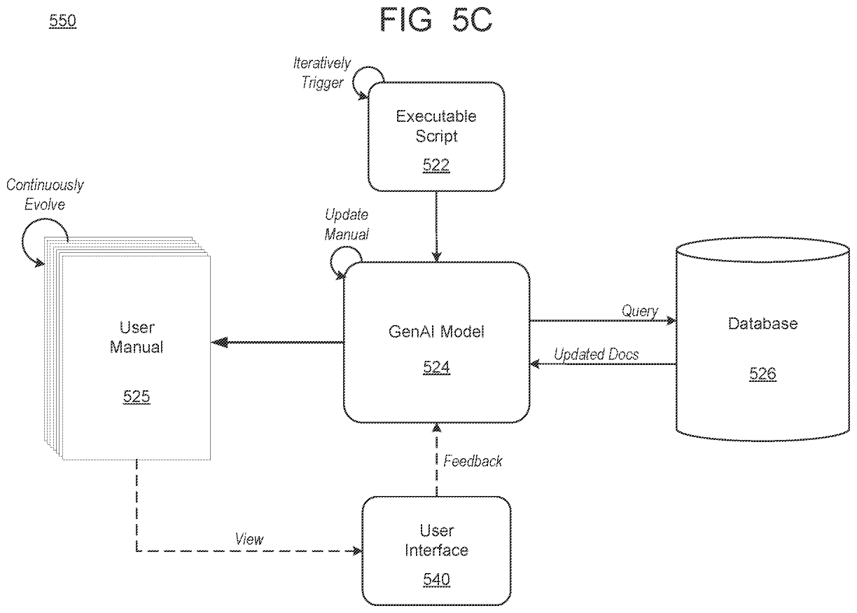

FIGS. 5A-5C illustrates a process of continuously updating a user manual of compliance according to example embodiments. For example, FIG. 5A illustrates a process 500 of managing a continuously evolving user manual 525 that includes rules to be followed by users, such as a group of users within an organization. The process 500 may be carried out by a software application 521 hosted by a host platform 520, such as a cloud platform, a web server, an on-premises server, or the like. The User Manual 525 may include training materials that instruct a user on how to use machinery, equipment, software programs, controls, servers, networks, and the like. As another example, the user manual 525 may include policy information that users must comply with. The policies may include security policies, data sharing policies, gifting policies, messaging policies, safety policies, and/or the like associated with a particular group, organization, standard, or the like.

According to various embodiments, the user manual 525 may be accessible to users via a software application 521. In this example, the users may operate devices that connect to the host platform 520 over a network such as the Internet and interact with the software application 521 via a web browser, mobile application, etc., installed on the devices. For example, in FIG. 5A, a user device 510 may submit a query to the software application 521, for example, via a user interface. The query may include a request for a particular rule that is to be followed when sending gifts to people outside of an organization. Here, the software application 521 may input the query term(s) into a GenAI model 524, which is configured to retrieve a portion of the user manual 525 and generate a document 514 with information about the requested policy and transmit the document 514 to the user device 510. The document 514 may include a copy of a page or segment of an organizational document that describes the policy.

As another example, the software application 521 may monitor communications (e.g., emails, text messages, meetings, etc.) of a user device 512 with one or more other users. Here, the communications may be outside or inside of an organization.

The software application 521 may provide the content from the communications to the GenAI model 524.

Here, the GenAI model 524 can detect a failure in compliance with the user manual 525. In response, the software application 521 may generate a response such as an alert that is sent to the user device 512. As another example, the software application 521 may take action to prevent the user device 512 from sending additional communications, such as communication 516, from being sent by an email system 523.

FIG. 5B illustrates a process 540 of iteratively updating training documents that are used to train the GenAI model 524 shown in FIG. 5A, and FIG. 5C illustrates a process 550 of iteratively updating the user manual 525 based on the iteratively updated training documents that are updated by the process shown in FIG. 5B. Referring to FIG. 5B, the user manual 525 may continuously evolve.

Here, the GenAI model 524 may iteratively ingest additional training documents and/or updates to training documents and update the user manual 525 on an iterative basis with new content (e.g., new rules, policies, etc.) and changes to content (e.g., changes to existing rules, policies, etc.).

Here, an executable script 522 may trigger a crawl process 528 to crawl multiple data stores, including a training manual data store 530, a compliance document data store 532, and a best practice documents database 534. For example, the executable script 522 may detect a triggering condition such as a point in time (e.g., every day at 7 a.m., etc.) As another example, the executable script 522 may detect an event-based trigger, such as a request submitted from another application, a user interface, etc. The updated documents may retrieved by querying endpoints 531, 533, and 535, corresponding to the training manual data store 530, the compliance document data store 532, and the best practice documents database 534, respectively.

The new/updated documents may be stored within a database 526 to be used for updating the user manual 525.

For example, in FIG. 5C, the executable script 522 iteratively triggers the GenAI model 524 to update the user manual 525 based on newly retrieved documents and data. Here, the GenAI model 524 may compare the content that is currently within the user manual 525 to content in the new documents and identify changes to policies/rules, new policies/rules, etc. The GenAI model 524 may then generate content corresponding to the new or updated rules/policies and store it within the user manual 525. For example, the GenAI model 524 may ingest the documents retrieved in FIG. 5B from the database 526, and generate the new content in response. Furthermore, the system may display a user interface 560 with a description of the user manual for feedback from a user. Thus, a user can validate the updates to the user manual 525 if need be.

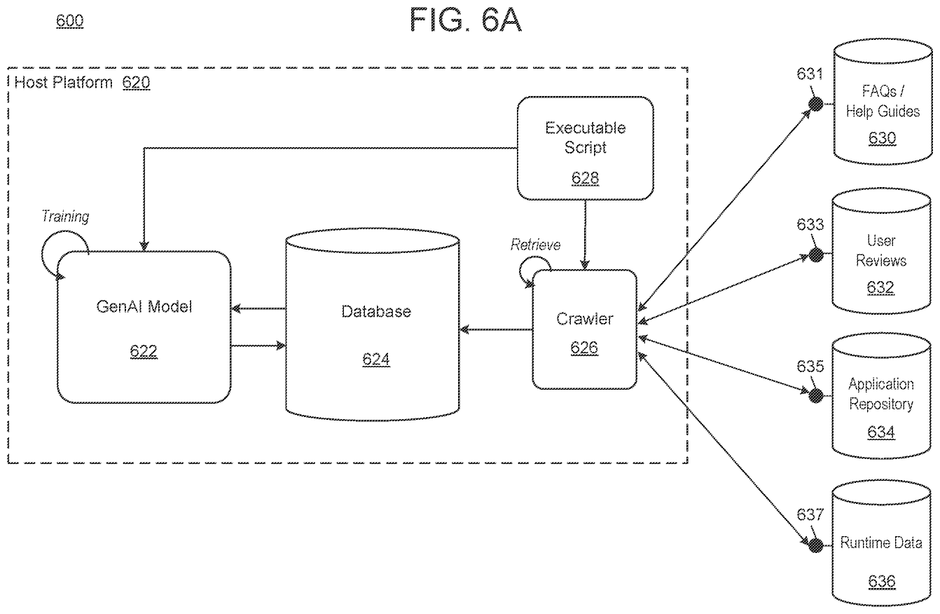

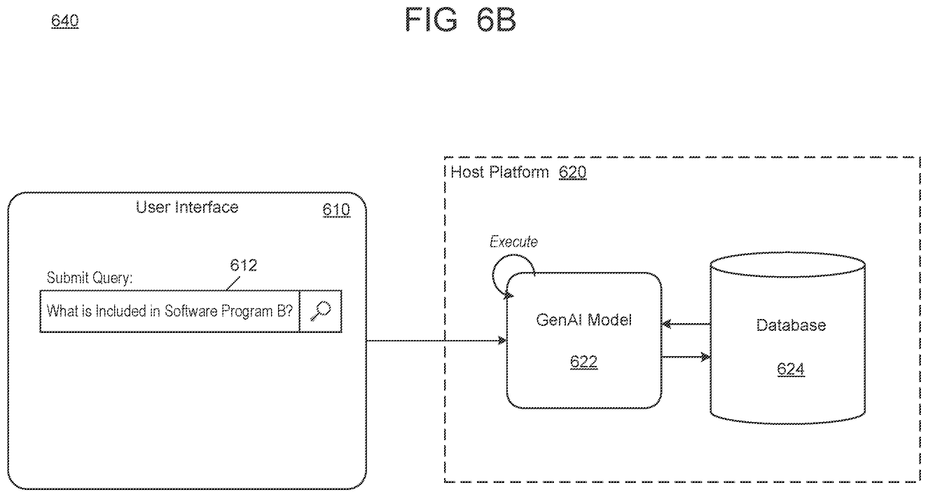

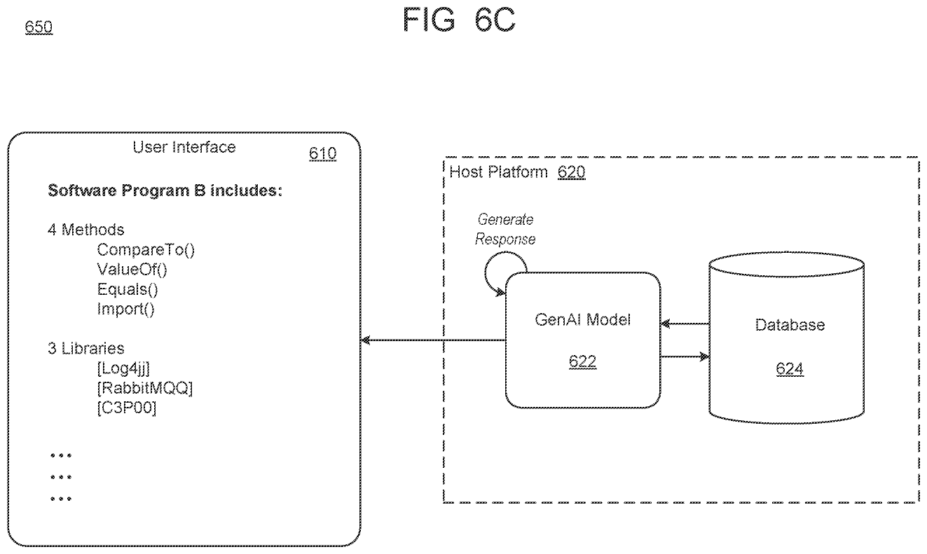

FIG. 6A-6C illustrates a process of answering questions about a software program according to example embodiments. For example, FIG. 6A illustrates a process 600 of training a GenAI model to understand a software program such as a software application, a microservice, an application programming interface (API), or the like.

In this example, a host platform 620 hosts a GenAI model 622, which is trained based on data stored within a database 624. The data may include data and documentation associated with the software program, such as FAQs, help guides, user reviews, and the like, of the software program. As another example, the data may include source code, best practice documents, runtime data of the software program running in a live execution environment, and/or the like.

In this example, an executable script 628 may trigger a crawler 626 to crawl various endpoints 631, 633, 635, and 637 of data stores 630, 632, 634, and 636, respectively, for data, files, documents, etc., about the software program. In some embodiments, the process 600 may include transferring data to an API or the like. The data may be extracted from one or more of the data stores 630, 632, 634, and 636 and ingested by the GenAI model 622 by executing the GenAI model on the content/text within the documents, files, etc.

FIG. 6B illustrates a process 640 of receiving a natural language input and generating a description of a software program based on the natural language input and FIG. 6B illustrates a process 650 of outputting a generated description of the software program to a user interface 610. As an example, the user interface 610 may be displayed on a user device.

Referring to FIG. 6B, a user may “chat” with the database 624 and learn information about a software program held therein. For example, the user interface 610 may include one or more input fields 612 with areas for inputting content that can be transferred to the GenAI model 622 for execution. The content may include natural language text and other content, such as images, documents, etc., that is submitted to the GenAI model 622.

In response to receiving the input content, as shown in FIG. 6C, the GenAI model 622 may execute on text input and identify a response to the text input based on the documents and data ingested by the training process shown in FIG. 6A. Here, the GenAI model 622 may identify and generate a description of the software functionality, including descriptions of methods, functions, code modules, classes of code, APIs, etc., that are part of a software program and display them on the user interface 610. Thus, a user can ask a question about a software program held in an application repository of an organization and receive a description of the software program, its components, its function, and its uses.

In some embodiments, the runtime data ingested by the GenAI model, for example, from the data store 636, may be used to identify the components of the software program in real time based on the most recent execution of the software program. As another example, the description may be generated based on FAQs, help guides, user reviews, etc. The GenAI model 622 can receive questions and answer them in the form of text and/or images. The inputs to the model may include text and/or images. In some cases, the model may be a multimodal GenAI model. However, embodiments are not limited thereto.

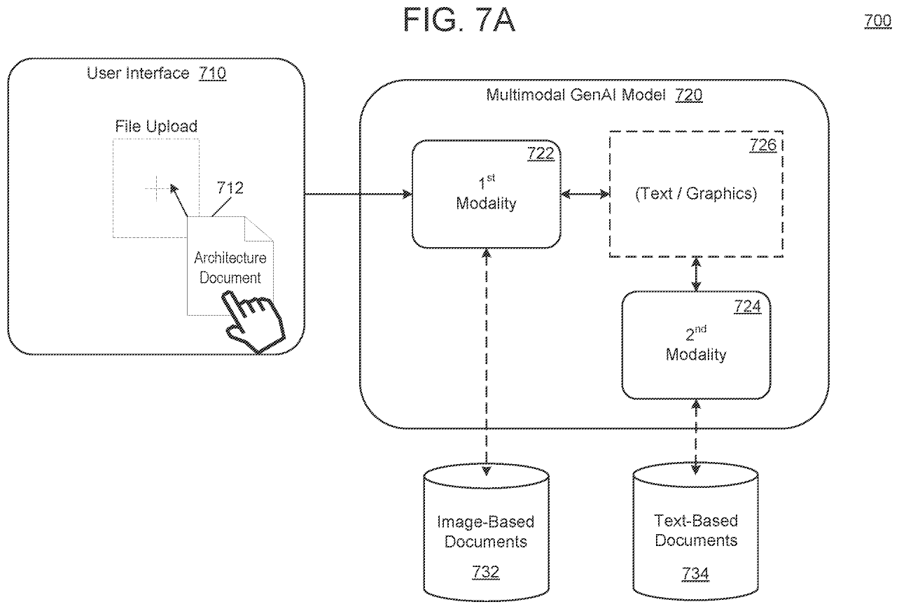

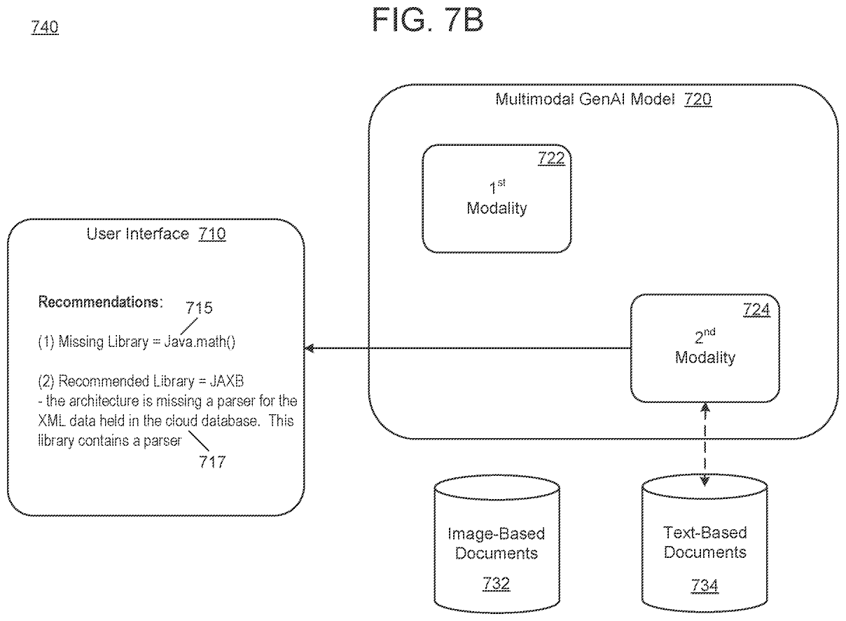

FIGS. 7A-7B illustrates a process of recommending a new software component based on a description of a software architecture according to example embodiments. For example, FIG. 7A illustrates a process 700 of a multimodal GenAI model 720 receiving a document 712 as an input, and FIG. 7B illustrates a process 740 of generating a description of a change to a software architecture based on the document and displaying the description on a user interface 710.

Referring to FIG. 7A, a user may upload a document 712, such as an architecture drawing that includes a diagram of a software architecture.

In response, the multimodal GenAI model 720 may convert the diagram into a description with image 726, such as a UML diagram or the like, via a first modality 722 of the multimodal GenAI model 720. In addition, the multimodal GenAI model 720 may convert the description with image 726 into a description via a second modality 724 of the multimodal GenAI model 720. Here, the first modality 722 operates on image data from a data store 732 and the second modality 724 operates on text data from a data store 734.

In response, the receiving the document 712, the multimodal GenAI model 720 may identify changes to be made to the software architecture, such as new programs to add, new functionality to add, updates to existing code, changes to providers, changes to APIs, and the like. For example, as shown in FIG. 7B, the multimodal GenAI model 720 may output a recommendation 715 of a missing library to be added to the software architecture, including a name and a description of the library.

As another example, the GenAI model 720 may output a recommendation 717 to fix/rework an existing code module, which in this example is a library. Furthermore, the user may enter additional questions that the GenAI model 720 can aggregate together with the rest of the conversation/chat and generate additional responses, including recommended source code for the recommended new comment or reworked component. Here, the source code may be displayed on the user interface 710.

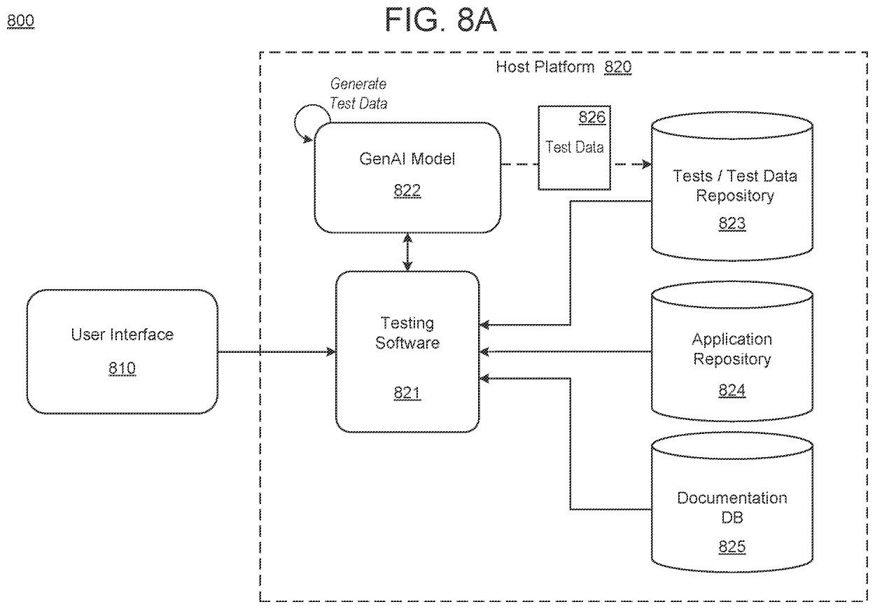

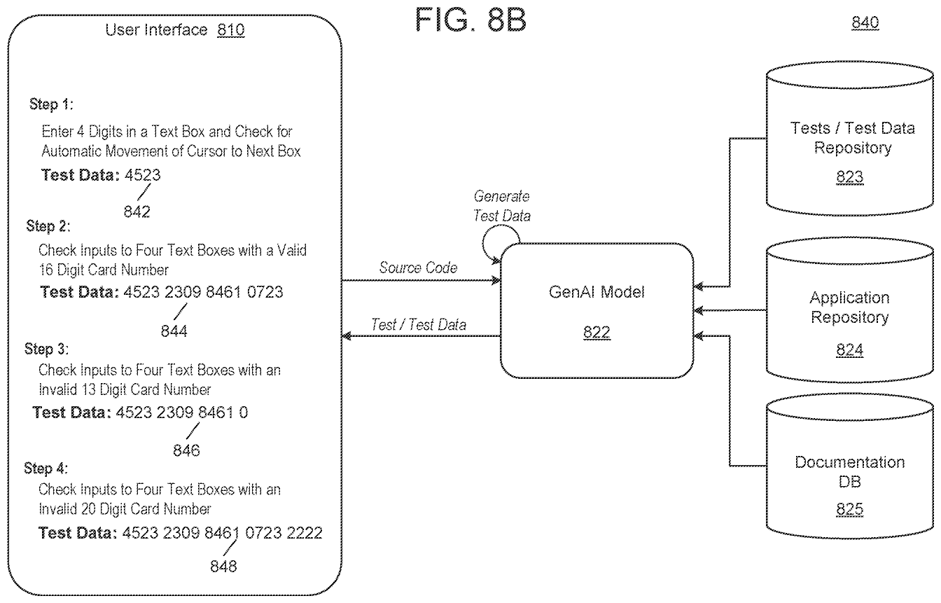

FIGS. 8A-8B illustrates a process of generating software tests and test data according to example embodiments. For example, FIG. 8A illustrates a process 800 of generating test data for a software program based on input received via a user interface 810 or other means. The input may be received by a testing software 821 hosted on a host platform 820.

The testing software 821 may include a description of the requirements of the test, such as the UI elements to be tested, the code module to be tested, the type of test, a description of the data needed for the test, and the like. Here, the input may be received via a testing software 821 associated with the user interface 810. The testing software may input the description into a GenAI model 822, which can generate test data 826 for the test and return it to the testing software 821.

The testing software 821 can display the test data 826 on the user interface 810, and the user can provide feedback and even accept the test data 826.

In this example, the GenAI model 822 is trained by ingesting historical software tests, historical test data, source code, best testing practice documentation, and the like. For example, the GenAI model 822 may be trained from data in any of the data store 823, 824, and 825. In addition to generating the test data, the GenAI model 822 may also generate the software tests themselves. Furthermore, the testing software 821 can test a software program based on the test data and/or the software test generated by the GenAI model 822.

For example, in FIG. 8B, a process 840 of displaying test data 842, 844, 846, and 848 on the user interface 810 is provided.

Here, the GenAI model 822 generates a sequence of test steps to be performed for a software test and test data for each step that is to be input by a user during the test. In particular, this test is for the functionality of a quadruple input field.

The system can train a generative AI model on the historical test data of a software application. Once trained, the generative AI model generates test data for a code module from a branch of code of the software application and stores the test data in a data repository. The system begins by ingesting past test data for the software application. This data would typically include inputs given to the application, expected outputs, and possibly the actual outputs. The historical test data should include edge case and boundary testing data. A typical software application comprises multiple code modules, each related to a functional area or feature of the application. These code modules are grouped together and maintained within code branches. Each branch of code represents a version of the application, with some versions designed to introduce new features and functionality while others deliver fixes. It is not uncommon for a modern software application to have multiple branches of code at any one time. Once the AI model is trained, it is tasked with generating test data for the software application's code modules from each branch of code. The resulting generated test data is then stored in a data repository to be integrated into the application testing process.

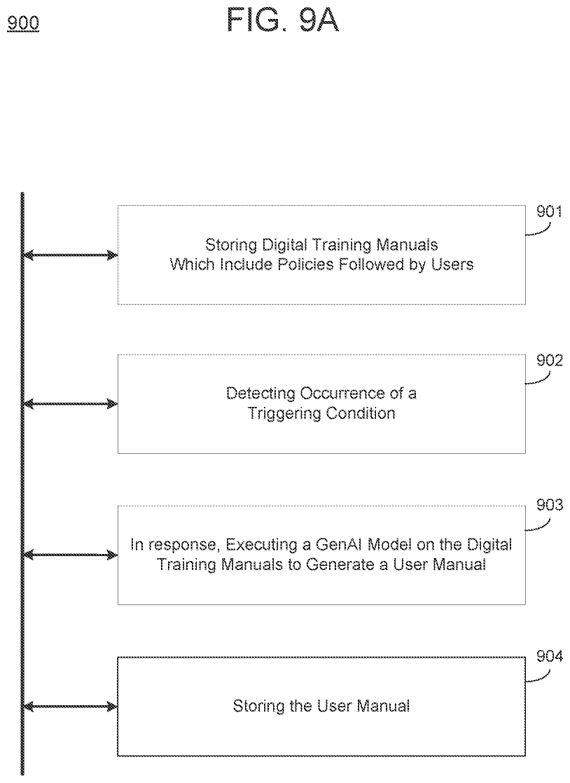

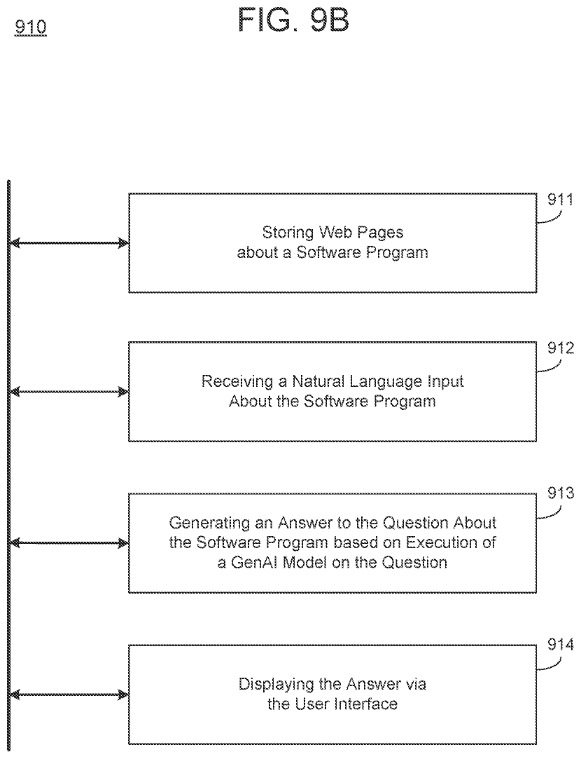

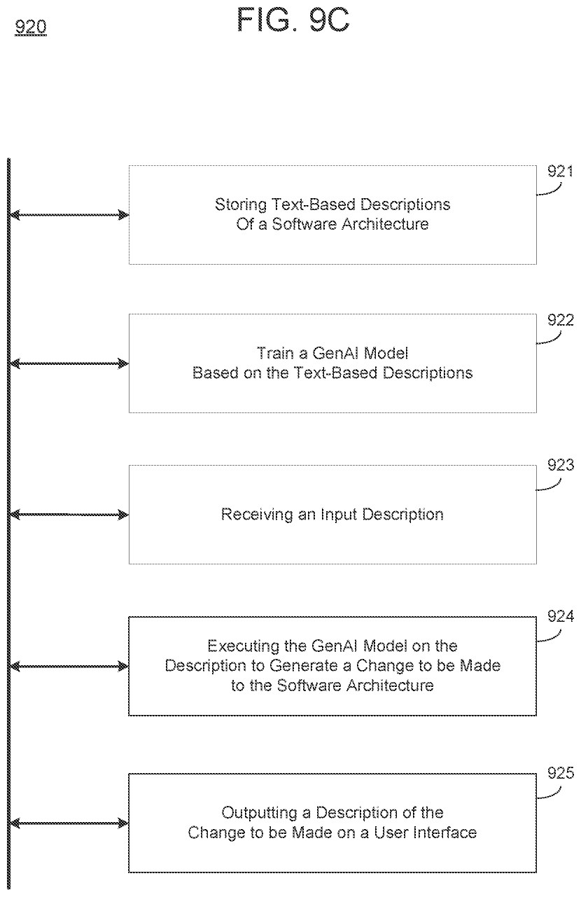

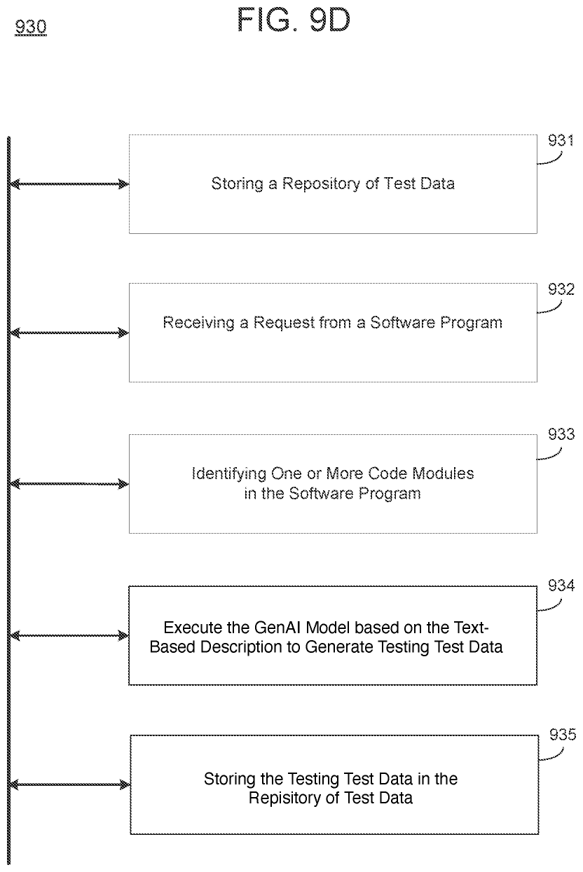

FIG. 9A illustrates a method 900 of generating an evolving user manual of compliance according to example embodiments. As an example, the method 900 may be performed by a computing system, a software application, a server, a cloud platform, a combination of systems, and the like.

Referring to FIG. 9A, in 901, the method may include storing a plurality of digital training manuals that comprise policies that are to be followed by users. In 902, the method may include detecting occurrence of a triggering condition. In response to the detection of the occurrence of the triggering condition, in 903, the method may include retrieving the plurality of digital training manuals from the memory and generating a user manual based on execution of a generative artificial intelligence (GenAI) model on the plurality of digital training manuals. In 904, the method may include storing the user manual in the memory.

In some embodiments, the method may further include ingesting one or more additional documents from one or more endpoints, and updating the plurality of digital training manuals within the memory based on the one or more additional documents. In some embodiments, the method may further include modifying the user manual based on execution of the GenAI model on the plurality of digital training manuals updated based on the one or more additional documents to generate an updated user manual. In some embodiments, the triggering condition may include a modification to the plurality of digital training manuals within the memory.

In some embodiments, the detecting may include reading timestamps from files of the plurality of digital training manuals stored in the memory, and determining that the plurality of digital training manuals have been modified based on a comparison of the read timestamps to previously read timestamps from the files. In some embodiments, the method may further include receiving a search input via a user interface, identifying a page within the user manual that corresponds to the search input based on a term included in the search input and terms included in the page, and displaying content from the page via the user interface.

In some embodiments, the method may further include displaying one or more prompts on a user interface based on the execution of the GenAI model, receiving one or more responses to the one or more prompts, and generating the user manual based on execution of the GenAI model on the one or more prompts and the one or more responses. In some embodiments, the method may further include retrieving a compliance document template from the memory, and generating the user manual based on execution of the GenAI model on the compliance document template.

FIG. 9B illustrates a method 910 of answering questions about a software program according to example embodiments. As an example, the method 910 may be performed by a computing system, a software application, a server, a cloud platform, a combination of systems, and the like.

Referring to FIG. 9B, in 911, the method may include storing web pages with content about a software program.

In 912, the method may include receiving a natural language input with a question about the software program from an input field of a user interface. In 913, the method may include generating an answer to the question about the software program based on execution of a generative artificial intelligence (GenAI) model on the question from the input field and the plurality of web pages stored in the memory. In 914, the method may include displaying the answer to the question via the user interface.

In some embodiments, generating the answer may include generating a natural language output based on text included in the web pages about the software program in the memory.

In some embodiments, the generating the answer may include generating a diagram based on diagrams included in the web pages about the software program in the memory. In some embodiments, the GenAI model may include a multi-model large language model (LLM), and the method may further include training the multimodal large language model to understand a correlation between text descriptions of the software program and diagram components of the software program.

In some embodiments, the method may further include receiving a response to the answer via the user interface, generating an additional answer based on execution of the GenAI model on the question, the answer, and the response to the answer, and displaying the additional answer via the user interface. In some embodiments, the method may further include receiving feedback about the answer via the user interface, retraining the GenAI model based on execution of the GenAI model on the question, the answer, and the feedback, and storing the retrained GenAI model in the memory. In some embodiments, the method may further include training the GenAI model based on text descriptions and diagrams of other software programs stored in the memory, prior to receipt of the natural language input.

FIG. 9C illustrates a method 920 of generating a description of a change to be made to a software architecture according to example embodiments. As an example, the method 920 may be performed by a computing system, a software application, a server, a cloud platform, a combination of systems, and the like. Referring to FIG. 9C, in 921, the method may include storing software architecture documents which include text-based descriptions of architecture components. In 922, the method may include training a generative artificial intelligence (GenAI) model to understand the architecture components based on the software architecture documents in the memory. In 923, the method may include receiving an input comprising a description of a software architecture implemented by a computing platform. In 924, the method may include executing the GenAI model based on the description of the software architecture to generate a description of a change to be made to the software architecture. In 925, the method may include outputting the description of the change on a user interface.

In some embodiments, the input may include a description of features to be included in the software architecture, and the software architecture documents comprise a combination of diagrams and descriptions of a plurality of different software architectures.

In some embodiments, the executing may include generating a diagram of the change to be made to the software architecture based on execution of the GenAI model on the description of the change, and the outputting comprises displaying the diagram via the user interface.

In some embodiments, the receiving may include displaying a sequence of prompts on the user interface and receiving a sequence of responses to the sequence of prompts via the user interface, respectively, and the executing further comprises generating the description of the change to be made to the software architecture based on execution of the GenAI model on the sequence of prompts and the sequence of responses.

In some embodiments, the method may further include generating a description of a new software component to add to the software architecture based on the execution of the GenAI model, and displaying the description of the new software component via the user interface. In some embodiments, the method may further include generating source code for the new software component based on the description of the new software component, and displaying the source code via the user interface. In some embodiments, the method may further include generating a description of a modification to an existing software component within the software architecture, and displaying the description of the modification via the user interface. In some embodiments, the input may include a digital document that includes the description of the software architecture, and the method further comprises converting text within the digital document into an encoding prior and inputting the encoding into the GenAI model.

FIG. 9D illustrates a method 930 of generating test data based on a natural language input according to example embodiments. As an example, the method 930 may be performed by a computing system, a software application, a server, a cloud platform, a combination of systems, and the like. Referring to FIG. 9D, in 931, the method may include storing a repository of test data. In 932, the method may include receiving a request for new test data to be generated for a software program, where the request comprises a text-based description of the new test data. In 933, the method may include identifying one or more code modules included in the software program based on source code of the software program stored in the memory. In 934, the method may include executing a generative artificial intelligence (GenAI) model on the text-based description of the new test data and the one or more code modules to generate testing test data for testing the one or more code modules. In 935, the method may include storing the testing test data in the repository of test data.

In some embodiments, the method may further include training the GenAI model to understand test data based on test data stored in the repository of test data. In some embodiments, the method may further include displaying the test data via a user interface, and receiving feedback about the test data via the user interface. In some embodiments, the method may further include updating the repository of test data with the test data and the feedback about the test data, and retraining the GenAI model based on execution of the GenAI model on the updated repository of test data.

In some embodiments, the method may further include displaying one or more prompts on a user interface based the execution of the GenAI model, receiving one or more responses to the one or more prompts, and generating the test data based on execution of the GenAI model on the one or more prompts and the one or more responses. In some embodiments, the method may further include displaying an input field via a user interface, receiving a search input term via the input field, and identifying a software program to be tested based on the search input term. In some embodiments, the method may further include identifying a subset of test data within the repository of test data that corresponds to the software program, and executing a test of the software program based on the subset of test data via a testing application.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

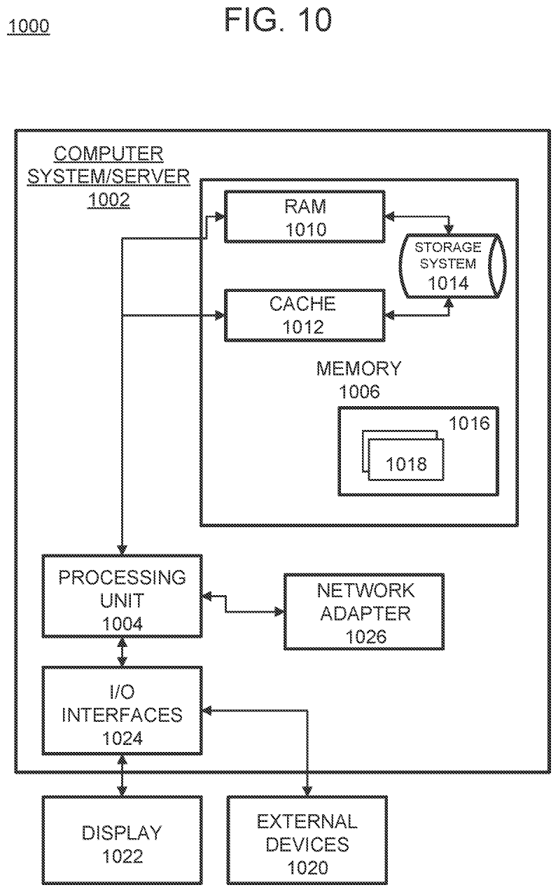

An exemplary storage medium may be coupled to the processor such that the processor may read information from, and write information to, the storage medium. In the alternative, the storage medium may be integral to the processor. The processor and the storage medium may reside in an application-specific integrated circuit (“ASIC”). In the alternative, the processor and the storage medium may reside as discrete components. For example, FIG. 10 illustrates an example computer system architecture, which may represent or be integrated in any of the above-described components, etc.

FIG. 10 illustrates an example system 1000 that supports one or more of the example embodiments described and/or depicted herein. The system 1000 comprises a computer system/server 1002, which is operational with numerous other general-purpose or special-purpose computing system environments or configurations. Examples of well-known computing systems, environments, and/or configurations that may be suitable for use with computer system/server 1002 include, but are not limited to, personal computer systems, server computer systems, thin clients, thick clients, hand-held or laptop devices, multiprocessor systems, microprocessor-based systems, set-top boxes, programmable consumer electronics, network PCs, minicomputer systems, mainframe computer systems, and distributed cloud computing environments that include any of the above systems or devices, and the like.

Computer system/server 1002 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 1002 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 10, computer system/server 1002 in the example system 1000 is shown in the form of a general-purpose computing device. The components of computer system/server 1002 may include, but are not limited to, one or more processors or processing units (processor 1004), a system memory 1006, and a bus that couples various system components including the system memory 1006 to the processor 1004.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 1002 typically includes a variety of computer system-readable media. Such media may be any available media that is accessible by computer system/server 1002, and it includes both volatile and non-volatile media, removable and non-removable media. The system memory 1006, in one embodiment, implements the flow diagrams of the other figures. The system memory 1006 can include computer system readable media in the form of volatile memory, such as random-access memory (RAM) 1010 and/or cache memory 1012. Computer system/server 1002 may further include other removable/non-removable, volatile/non-volatile computer system storage media. By way of example only, storage system 1014 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus by one or more data media interfaces. As will be further depicted and described below, the system memory 1006 may include at least one program product having a set (e.g., at least one) of program modules that are configured to carry out the functions of various embodiments of the application.

Program/utility 1016, having a set (at least one) of program modules 1018, may be stored in the system memory 1006 by way of example, and not limitation, as well as an operating system, one or more application programs, other program modules, and program data. Each of the operating system, one or more application programs, other program modules, and program data or some combination thereof, may include an implementation of a networking environment. Program modules 1018 generally carry out the functions and/or methodologies of various embodiments of the application as described herein.

As will be appreciated by one skilled in the art, aspects of the present application may be embodied as a system, method, or computer program product. Accordingly, aspects of the present application may take the form of an entirely hardware embodiment, an entirely software embodiment (including firmware, resident software, micro-code, etc.), or an embodiment combining software and hardware aspects that may all generally be referred to herein as a “circuit,” “module” or “system.” Furthermore, aspects of the present application may take the form of a computer program product embodied in one or more computer readable medium(s) having computer readable program code embodied thereon.

Computer system/server 1002 may also communicate with one or more external devices 1020 such as a keyboard, a pointing device, a display 1022, etc.; one or more devices that enable a user to interact with computer system/server 1002; and/or any devices (e.g., network card, modem, etc.) that enable computer system/server 1002 to communicate with one or more other computing devices. Such communication can occur via I/O interfaces 1024. Still yet, computer system/server 1002 can communicate with one or more networks such as a local area network (LAN), a general wide area network (WAN), and/or a public network (e.g., the Internet) via network adapter 1026. As depicted, network adapter 1026 communicates with the other components of computer system/server 1002 via a bus. It should be understood that although not shown, other hardware and/or software components could be used in conjunction with computer system/server 1002. Examples, include, but are not limited to: microcode, device drivers, redundant processing units, external disk drive arrays, RAID systems, tape drives, and data archival storage systems, etc.

Although an exemplary embodiment of at least one of a system, method, and computer readable medium has been illustrated in the accompanying drawings and described in the foregoing detailed description, it will be understood that the application is not limited to the embodiments disclosed but is capable of numerous rearrangements, modifications, and substitutions as set forth and defined by the following claims. For example, the system's capabilities of the various figures can be performed by one or more of the modules or components described herein or in a distributed architecture and may include a transmitter, receiver, or pair of both. For example, all or part of the functionality performed by the individual modules may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via a plurality of protocols. Also, the messages sent or received by any of the modules may be sent or received directly and/or via one or more of the other modules.

One skilled in the art will appreciate that a “system” could be embodied as a personal computer, a server, a console, a personal digital assistant (PDA), a cell phone, a tablet computing device, a smartphone, or any other suitable computing device, or combination of devices. Presenting the above-described functions as being performed by a “system” is not intended to limit the scope of the present application in any way but is intended to provide one example of many embodiments. Indeed, methods, systems, and apparatuses disclosed herein may be implemented in localized and distributed forms consistent with computing technology.

It should be noted that some of the system features described in this specification have been presented as modules in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together but may comprise disparate instructions stored in different locations, which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction or many instructions and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations, including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed but is merely representative of selected embodiments of the application.

One having ordinary skill in the art will readily understand that the above may be practiced with steps in a different order and/or with hardware elements in configurations that are different from those that are disclosed. Therefore, although the application has been described based on these preferred embodiments, it would be apparent to those of skill in the art that certain modifications, variations, and alternative constructions would be apparent.

While preferred embodiments of the present application have been described, it is to be understood that the embodiments described are illustrative only, and the scope of the application is to be defined solely by the appended claims when considered with a full range of equivalents and modifications (e.g., protocols, hardware devices, software platforms, etc.) thereto.

What is claimed is:

1. An apparatus comprising:
a display;
a memory configured to store web pages with content about a software program; and
a processor coupled to the display and the memory configured to:
receive a natural language input with a question about the software program from an input field of a user interface,
generate an answer to the question about the software program based on execution of a generative artificial intelligence (GenAI) model on the question from the input field and the web pages stored in the memory; and
display on the display the answer to the question via the user interface.

2. The apparatus of claim 1, wherein the answer comprises a natural language output that is generated by the GenAI model based on text included in the web pages about the software program in the memory.

3. The apparatus of claim 1, wherein the answer comprises a diagram that is generated by the GenAI model based on diagrams included in the web pages about the software program in the memory.

4. The apparatus of claim 1, wherein the GenAI model comprises a multi-modal large language model (LLM), and the processor is further configured to train the multi-modal large language model to understand a correlation between text descriptions of the software program and diagram components of the software program.

5. The apparatus of claim 1, wherein the processor is further configured to receive a response to the answer via the user interface, generate an additional answer based on execution of the GenAI model on the question, the answer, and the response to the answer, and display the additional answer via the user interface.

6. The apparatus of claim 1, wherein the processor is further configured to receive feedback about the answer via the user interface, retrain the GenAI model based on execution of the GenAI model on the question, the answer, and the feedback, and store the retrained GenAI model in the memory.

7. The apparatus of claim 1, wherein the processor is further configured to train the GenAI model based on text descriptions and diagrams of other software programs stored in the memory, prior to receipt of the natural language input.

8. A method comprising:
storing web pages with content about a software program;
receiving a natural language input with a question about the software program from an input field of a user interface,
generating an answer to the question about the software program based on execution of a generative artificial intelligence (GenAI) model on the question from the input field and the web pages stored in memory; and
displaying the answer to the question via the user interface.

9. The method of claim 8, wherein the generating the answer comprises generating a natural language output based on text included in the web pages about the software program in the memory.

10. The method of claim 8, wherein the generating the answer comprises generating a diagram based on diagrams included in the web pages about the software program in the memory.

11. The method of claim 8, wherein the GenAI model comprises a multi-modal large language model (LLM), and the method further comprises training the multi-modal large language model to understand a correlation between text descriptions of the software program and diagram components of the software program.

12. The method of claim 8, wherein the method further comprises receiving a response to the answer via the user interface, generating an additional answer based on execution of the GenAI model on the question, the answer, and the response to the answer, and displaying the additional answer via the user interface.

13. The method of claim 8, wherein the method further comprises receiving feedback about the answer via the user interface, retraining the GenAI model based on execution of the GenAI model on the question, the answer, and the feedback, and storing the retrained GenAI model in the memory.

14. The method of claim 8, wherein the method further comprises training the GenAI model based on text descriptions and diagrams of other software programs stored in the memory, prior to receipt of the natural language input.

15. A computer-readable medium comprising instructions stored therein which when executed by a processor cause a computer to perform:
storing web pages with content about a software program;
receiving a natural language input with a question about the software program from an input field of a user interface,
generating an answer to the question about the software program based on execution of a generative artificial intelligence (GenAI) model on the question from the input field and the web pages stored in memory; and
displaying the answer to the question via the user interface.

16. The computer-readable medium of claim 15, wherein the generating the answer comprises generating a natural language output based on text included in the web pages about the software program in the memory.

17. The computer-readable medium of claim 15, wherein the generating the answer comprises generating a diagram based on diagrams included in the web pages about the software program in the memory.

18. The computer-readable medium of claim 15, wherein the GenAI model comprises a multi-modal large language model (LLM), and the instructions, when executed by the processor, cause the processor to perform training the multi-modal large language model to understand a correlation between text descriptions of the software program and diagram components of the software program.

19. The computer-readable medium of claim 15, wherein the instructions, when executed by the processor, cause the processor to perform receiving a response to the answer via the user interface, generating an additional answer based on execution of the GenAI model on the question, the answer, and the response to the answer, and displaying the additional answer via the user interface.

20. The computer-readable medium of claim 15, wherein the instructions, when executed by the processor, cause the processor to perform receiving feedback about the answer via the user interface, retraining the GenAI model based on execution of the GenAI model on the question, the answer, and the feedback, and storing the retrained GenAI model in the memory.
